(19) United States
(12) Patent Application Publication
(10) Pub. No.: US 2025/0366680 A1
(43) Pub. Date: Dec. 4, 2025

(54) HANDHELD VACUUM CLEANER FOR PETS

(71) Applicant: Ningbo Brightech International Trading CO., LTD., Yuyao (CN)

(72) Inventors: Jun YE, Yuyao (CN); Jinqi LU, Yuyao (CN)

(73) Assignee: Ningbo Brightech International Trading CO., LTD., Yuyao (CN)

(21) Appl. No.: 18/916,143

(22) Filed: Oct. 15, 2024

(30) Foreign Application Priority Data
Jun. 4, 2024 (CN) 202421252170.4

(51) Int. Cl. A47L 7/00; A01K 13/00; A47L 5/24; A47L 9/00; A47L 9/04; A47L 9/14; A47L 9/28; A47L 9/30; A47L 9/32

(52) U.S. Cl. CPC A47L 7/0066; A01K 13/002; A47L 5/24; A47L 9/0063; A47L 9/0405; A47L 9/0461; A47L 9/1427; A47L 9/149; A47L 9/2857; A47L 9/2873; A47L 9/2884; A47L 9/30; A47L 9/322

(57) ABSTRACT

The present invention discloses a handheld vacuum cleaner for pets, including a body, a charging base, a dust suction port, a cleaning accessory, and the like. A trigger is arranged on the body on a side of the dust suction port, and a driving member is arranged in the cleaning accessory. When the cleaning accessory is inserted into the dust suction port, the driving member can be brought into contact with the trigger, and the driving member can be driven by a pressing operation of the trigger to perform hair removal on the cleaning accessory. With this structure, a user can simultaneously perform grooming and dust suction and remove hair adhering to the cleaning accessory by holding the body with a single hand, which is simpler and more labor-saving in use. Moreover, the internally mounted driving member also makes the entire cleaning accessory compact and aesthetic in appearance. In addition, a dust canister removably mounted to a rear part of the body can be prevented from being occluded, which is convenient for the user to clearly observe an operating condition inside the dust canister during use. In particular, a position of the rear dust canister is separate from a position of the front dust suction port, so that the dust canister can be made larger and longer, and a storage capacity of the dust canister is also increased.

### CROSS-REFERENCE TO RELATED APPLICATION

This disclosure claims priority to Chinese Patent Application No. 202421252170.4 filed on Jun. 4, 2024, the disclosure of which is incorporated herein by reference in its entirety.

### TECHNICAL FIELD

The present invention relates to a handheld vacuum cleaner, and in particular, to a handheld vacuum cleaner for pets for sucking away pet hair during combing of the pet hair.

### BACKGROUND

Currently, hair combing is often performed on a household pet. However, during the hair combing, fallen hair often adheres to a combing tool and floats on a surrounding ground. Therefore, a handheld vacuum cleaner for pets having both hair combing and hair absorbing functions is launched on the market. A structure thereof is mainly composed of a body, a vacuum motor inside the body, a dust canister removably mounted to the body, a dust suction port in communication with the dust canister, a cleaning accessory removably inserted into the dust suction port, and the like. An adsorption port in communication the dust suction port is provided on the cleaning accessory. During operation, a suction force generated by the vacuum motor directly acts on the adsorption port on the cleaning accessory, so that hair fallen during combing of a pet by the cleaning accessory can be directly sucked into the dust canister. In addition, the cleaning accessory usually has a driving member, and hair adhering to the cleaning accessory is removed through operation of the driving member. However, the driving member on the conventional cleaning accessory is directly arranged externally on the cleaning accessory, and the externally arranged driving member often protrudes from an outer surface of the cleaning accessory. First, this affects overall compactness and an aesthetic appearance of the cleaning accessory. Second, pressing the driving member on the cleaning accessory with a relatively small volume to perform the hair removal operation makes the finger pressing operation quite laborious. Third, when the hair adhering to the cleaning accessory needs to be removed during use of the vacuum cleaner, a user needs to hold the body with one hand to stabilize the vacuum cleaner, and then press the driving member with the other hand to perform the hair removal operation. In other words, both hands need to cooperate in the operation, which makes the whole use process quite troublesome. In addition, the dust canister of the conventional handheld vacuum cleaner for pets is usually designed on a front part of the body. In actual use, the dust canister is occluded by a rear part of a body of the internally arranged vacuum motor. This makes it difficult to clearly observe an operating condition inside the dust canister during the use. Moreover, the dust suction port is also arranged on the front part, resulting in that the front dust canister cannot be made larger and longer as a result of compression of the position of the dust suction port, and affecting a storage capacity of the dust canister.

### SUMMARY

A technical problem to be resolved in the present invention is to overcome shortcomings in the prior art and provide a handheld vacuum cleaner for pets that can simultaneously perform hair combing and dust suction and remove hair adhering to a cleaning accessory by holding a body with a single hand, which is simpler and more labor-saving in use, can help clearly observe an operating condition of a dust canister, and can be configured with the dust canister with a larger capacity.

The technical problem is to be resolved by the present invention through the following technical solutions.

A handheld vacuum cleaner for pets is provided, including a body, a vacuum motor inside the body, a dust canister removably mounted to the body, a dust suction port in communication with the dust canister, and a cleaning accessory removably inserted into the dust suction port. The cleaning accessory has a driving member to drive hair removal. An adsorption port in communication with the dust suction port is arranged on the cleaning accessory. A trigger is arranged on the body on a side of the dust suction port. The driving member is arranged in the cleaning accessory. The cleaning accessory is inserted into the dust suction port, and brings the driving member into contact with the trigger. The trigger performs a pressing operation, and drives the driving member to perform hair removal on the cleaning accessory.

The body is composed of a head, a dust suction chamber at a bottom of the head, and a handle at a bottom of the dust suction chamber. The vacuum motor is arranged in the head. The dust canister is removably mounted to a rear part of the head. The dust suction port is externally provided on a front part of the dust suction chamber. The dust suction chamber is brought into communication with the dust canister through an outlet of a rear part.

A side hole is provided on a bottom of the dust canister, and the dust canister is mounted to the rear part of the head, and brings the side hole into hermetic communication with the outlet of a rear part of the dust suction chamber.

A canister opening and a detachable canister lid hermetically covering the canister opening are provided on a rear part of the dust canister.

An accessory release button is arranged on each of two side surfaces of the front part of the dust suction chamber, and a dust canister release button is arranged on a side surface of the rear part of the dust suction chamber.

The trigger is arranged on a front side of a top of the handle, and is located below the dust suction port.

A battery is arranged in the handle. The handle is inserted into a charging base.

A charging indicator light and a switch speed regulation toggle are arranged on an outer surface of the handle.

The charging base has a flat bottom surface, an arc-shaped top surface, and two semicircular side surfaces.

A handle socket and a plurality of accessory sockets are arranged on the top surface of the charging base. The handle is inserted into the handle socket and charges the battery. The cleaning accessory is inserted into each of the accessory sockets.

Compared with the prior art, in the present invention, the trigger is arranged on the body on the side of the dust suction port, and the driving member is arranged in the cleaning accessory. When the cleaning accessory is inserted into the dust suction port, the driving member can be brought into contact with the trigger. Therefore, the trigger is operated to perform the pressing operation, so that the driving member may be driven to perform the hair removal on the cleaning accessory. Apparently, since the trigger driving the driving member is also arranged on the body, a user only needs to hold the body with a single hand to simultaneously perform hair combing and dust suction and remove the hair adhering to the cleaning accessory, without a need to press the driving member on the cleaning accessory with a relatively small volume for the hair removal operation by hand, which is simpler and more labor-saving in use. Moreover, the driving member internally arranged in the cleaning accessory does not protrude from an outer surface of the cleaning accessory, which also makes the entire cleaning accessory compact and aesthetic in appearance. In addition, the dust canister being removably mounted to the rear part of the body can be prevented from being occluded, which is convenient for the user to clearly observe the operating condition inside the dust canister during use. In particular, a position of the rear dust canister is separate from a position of the front dust suction port, so that the dust canister does not compress a mounting space due to being limited by the position of the dust suction port, thereby ensuring that the dust canister can be made larger and longer, to increase the storage capacity of the dust canister.

### BRIEF DESCRIPTION OF THE DRAWINGS

FIG. 1 is a cross-sectional view of the present invention.

FIG. 2 is a left view of FIG. 1.

FIG. 3 is a left view of FIG. 2.

FIG. 4 is a cross-sectional view taken along A-A in FIG. 3.

FIG. 5 is a three-dimensional view of the present invention.

### DETAILED DESCRIPTION

Embodiments of the present invention are described in detail below with reference to the above accompanying drawings.

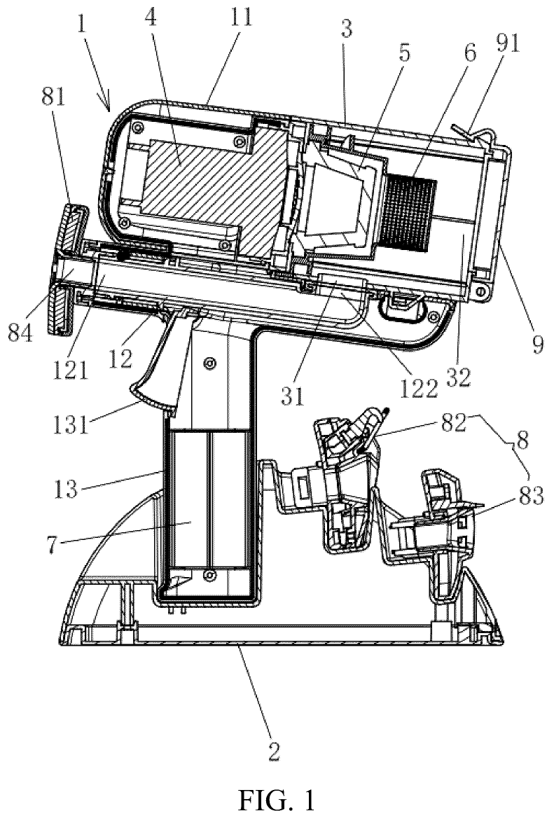

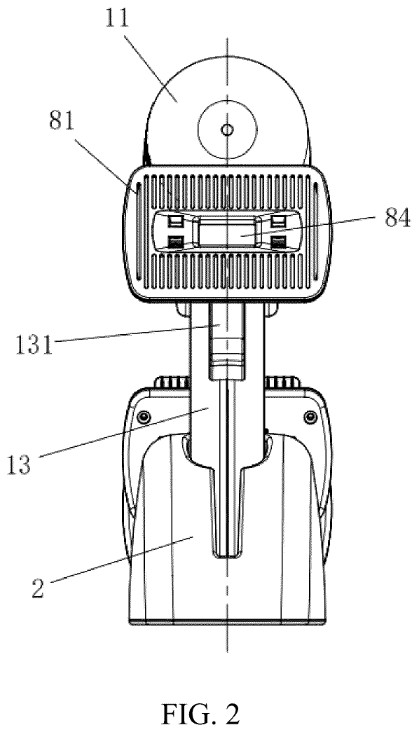

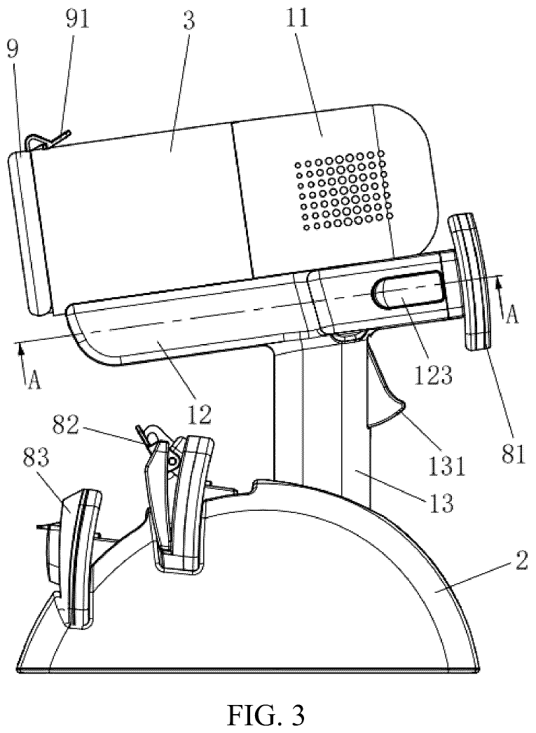

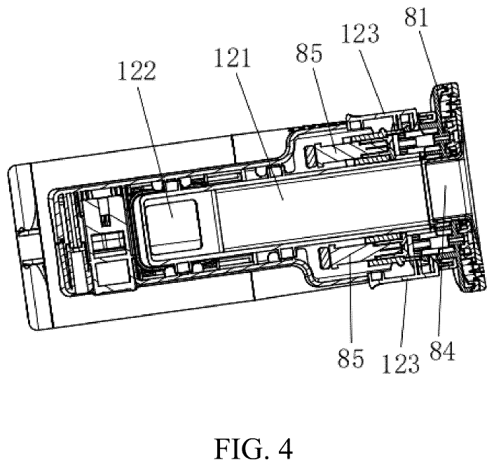

As shown in FIG. 1 to FIG. 5, 1. Body, 11. Head, 12. Dust suction chamber, 121. Dust suction port, 122. Outlet, 123. Accessory release button, 124. Dust canister release button, 13. Handle, 131. Trigger, 132. Charging indicator light, 133. Switch speed regulation toggle, 2. Charging base, 3. Dust canister, 31. Side hole, 32. Canister opening, 4. Vacuum motor, 5. High-efficiency particulate air (HEPA) filter, 6. Filter cover, 7. Battery, 8. Cleaning accessory, 81. Needle comb, 82. Dematting comb, 83. Thinning brush, 84. Adsorption port, 85. Driving member, 9. Canister lid, 91. Elastic latch.

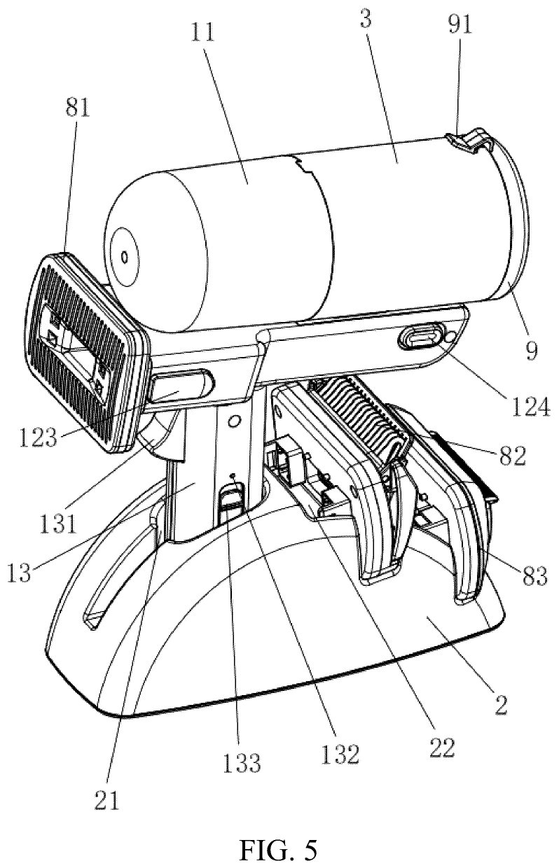

A handheld vacuum cleaner for pets, as shown in FIG. 1 and FIG. 5, is mainly configured to suction away pet hair during hair combing. A structure thereof includes a body 1, a charging base 2 at a bottom of the body, a vacuum motor 4, a HEPA filter 5, a filter cover 6, and a battery 7 inside the body, a dust canister 3 removably mounted to the body 1, a dust suction port 121 in communication with the dust canister, and a cleaning accessory 8 removably inserted into the dust suction port.

The body 1 is composed of a head 11, a dust suction chamber 12 at a bottom of the head, and a handle 13 at a bottom of the dust suction chamber. The head 11 and the dust canister 3 are both in a shape of a cylinder that is horizontally placed. The dust suction chamber 12 is a rectangular channel that is horizontally placed, and the handle 13 is a vertical long handle. Therefore, an overall shape of the body 1 is similar to a shape of a handgun.

The vacuum motor 4, the HEPA filter 5, and the filter cover 6 are arranged in the head 11. The dust canister 3 is removably mounted to a rear part of the head 11, the dust suction port 121 is externally arranged on a front part of the dust suction chamber 12, and the dust suction chamber is in communication with the dust canister 3 through an outlet 122 of a rear part. Specifically, a side hole 31 is provided on an outer circumferential surface of a bottom of the dust canister 3. After the dust canister 3 is mounted in place to the rear part of the head 11, the side hole 31 is just brought into hermetic communication with the outlet 122 of the rear part of the dust suction chamber 12.

Certainly, the dust canister 3 is usually mounted to the rear part of the head 11 by positioning mounting, to ensure that the side hole 31 is accurately brought into communication with the outlet 122. Therefore, as shown in FIG. 5, a positioning protrusion and a positioning slot for positioning mounting may be provided between the dust canister 3 and the head 11.

Apparently, the dust canister 3 being removably mounted to the rear part of the head 11 can be prevented from being occluded, which is convenient for a user to clearly observe an operating condition inside the dust canister 3 during use. In particular, a position of the rear dust canister is separate from a position of the front dust suction port, so that the dust canister 3 does not compress a mounting space as limited by the position of the dust suction port 121, thereby ensuring that the dust canister 3 can be made larger and longer, to increase a storage capacity of the dust canister 3.

A canister opening 32 and a detachable canister lid 9 hermetically covering the canister opening are provided on a rear part of the dust canister 3. In this embodiment, the canister lid 9 is connected to a bottom of the canister opening 32 through a hinge, so that the canister lid 9 may be opened and closed about the hinge to expose and cover the canister opening 32. An elastic latch 91 is arranged on a top of the canister lid 9, which can perform locking when the canister lid 9 hermetically covers the canister opening 32.

An accessory release button 123 is arranged on each of two side surfaces of the front part of the dust suction chamber 12, and the cleaning accessory 8 can be detached and removed from the dust suction port 121 through simultaneously pressing the accessory release buttons 123 on the two side surfaces. A dust canister release button 124 is arranged on a side surface of the rear part of the dust suction chamber 12, and the dust canister 3 can be detached and removed from the rear part of the head 11 through pressing the dust canister release button 124 on the side surface.

The cleaning accessory 8 has a driving member 85 to drive hair removal. An adsorption port 84 in communication with the dust suction port 121 is arranged on the cleaning accessory 8. The driving member 85 is arranged in the cleaning accessory 8. The driving member 85 in this embodiment is a driving rod.

A trigger 131 is arranged on the body 1 on a side of the dust suction port 121. Specifically, as shown in FIG. 1, the trigger 131 is arranged on a front side of a top of the handle 13, and is located below the dust suction port 121. When the cleaning accessory 8 is inserted into the dust suction port 121, the driving member 85 can be brought into contact with the trigger 131. Therefore, the trigger 131 is operated to perform a pressing operation, so that the driving member 85 can be driven to perform the hair removal on the cleaning accessory 8.

In this way, since the trigger 131 driving the driving member 85 is also arranged on the body 1, the user only needs to hold the handle 13 of the body 1 with a single hand to simultaneously perform hair combing and dust suction and remove hair adhering to the cleaning accessory 8, without a need to press the driving member 85 on the cleaning accessory 8 with a relatively small volume for the hair removal operation by hand, which is simpler and more labor-saving in use. Moreover, the driving member 85 internally arranged in the cleaning accessory 8 does not protrude from an outer surface of the cleaning accessory, which also makes the entire cleaning accessory 8 compact and aesthetic in appearance.

The battery 7 is arranged in the handle 13. A charging contact piece for charging the battery 7 is arranged on the bottom of the handle. A charging indicator light 132 and a switch speed regulation toggle 133 are arranged on an outer surface of the handle 13. The charging indicator light 132 is configured to display a charging condition of the battery 7. The switch speed regulation toggle 133 is configured to control on and off and speed regulation of the vacuum motor 4.

The charging base 2 has a flat bottom surface, an arc-shaped top surface, and two semicircular side surfaces, and is generally in a shape of a semicircular disc that is vertically placed. A handle socket 21 and a plurality of accessory sockets 22 are arranged on a top surface of the charging base 2, and the handle 13 is inserted into the handle socket 21 and can charge the battery 7. The cleaning accessory 8 may be inserted into each of the accessory sockets 22. As shown in FIG. 5, three cleaning accessories are provided, including a needle comb 81 inserted into the dust suction port 121 and a dematting comb 82 and a thinning brush 83 respectively inserted into two accessory sockets 22.

The above descriptions are only specific embodiments of the present invention. A person skilled in the art should understand that any structural design equivalent to this embodiment shall fall within the protection scope of the present invention.

What is claimed is:

1. A handheld vacuum cleaner for pets, comprising a body (1), a vacuum motor (4) inside the body, a dust canister (3) removably mounted to the body (1), a dust suction port (121) in communication with the dust canister, and a cleaning accessory (8) removably inserted into the dust suction port, wherein the cleaning accessory has a driving member (85) to drive hair removal, an adsorption port (84) in communication with the dust suction port (121) is arranged on the cleaning accessory (8), a trigger (131) is arranged on the body (1) on a side of the dust suction port (121), the driving member (85) is arranged in the cleaning accessory (8), the cleaning accessory is inserted into the dust suction port (121) and brings the driving member (85) into contact with the trigger (131), and the trigger (131) performs a pressing operation, and drives the driving member (85) to perform hair removal on the cleaning accessory (8).

2. The handheld vacuum cleaner for pets according to claim 1, wherein the body (1) is composed of a head (11), a dust suction chamber (12) at a bottom of the head, and a handle (13) at a bottom of the dust suction chamber, the vacuum motor (4) is arranged in the head (11), the dust canister (3) is removably mounted to a rear part of the head (11), the dust suction port (121) is externally provided on a front part of the dust suction chamber (12), and the dust suction chamber is brought into communication with the dust canister (3) through an outlet (122) of the rear part.

3. The handheld vacuum cleaner for pets according to claim 2, wherein a side hole (31) is provided on a bottom of the dust canister (3), and the dust canister (3) is mounted to the rear part of the head (11), and brings the side hole (31) into hermetic communication with the outlet (122) of a rear part of the dust suction chamber (12).

4. The handheld vacuum cleaner for pets according to claim 1, wherein a canister opening (32) and a detachable canister lid (9) hermetically covering the canister opening are provided on a rear part of the dust canister (3).

5. The handheld vacuum cleaner for pets according to claim 2, wherein an accessory release button (123) is arranged on each of two side surfaces of the front part of the dust suction chamber (12), and a dust canister release button (124) is arranged on a side surface of the rear part of the dust suction chamber (12).

6. The handheld vacuum cleaner for pets according to claim 1, wherein the trigger (131) is arranged on a front side of a top of the handle (13), and is located below the dust suction port (121).

7. The handheld vacuum cleaner for pets according to claim 1, wherein a battery (7) is arranged in the handle (13), and the handle is inserted into a charging base (2).

8. The handheld vacuum cleaner for pets according to claim 7, wherein a charging indicator light (132) and a switch speed regulation toggle (133) are arranged on an outer surface of the handle (13).

9. The handheld vacuum cleaner for pets according to claim 7, wherein the charging base (2) has a flat bottom surface, an arc-shaped top surface, and two semicircular side surfaces.

10. The handheld vacuum cleaner for pets according to claim 9, wherein a handle socket (21) and a plurality of accessory sockets (22) are arranged on the top surface of the charging base (2), the handle (13) is inserted into the handle socket (21) and charges the battery (7), and the cleaning accessory (8) is inserted into each of the accessory sockets (22).
